(19) United States
(12) Patent Application Publication
(10) Pub. No.: US 2005/0269931 A1
(43) Pub. Date: Dec. 8, 2005

(54) Flat fluorescent lamp, method of manufacturing the same, and display device having the same

(75) Inventors: Joong-Hyun Kim, Gyeonggi-do (KR); Hae-Soo Ha, Gyeonggi-do (KR); Sang-Yu Lee, Gyeonggi-do (KR); In-Sun Hwang, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(73) Assignees: Samsung Electronics Co. Ltd; Samsung Corning Co. Ltd.

(21) Appl. No.: 11/143,320

(22) Filed: Jun. 1, 2005

(30) Foreign Application Priority Data
Jun. 7, 2004 (KR) 10-2004-0041257

(51) Int. Cl. H01J 1/62; H01J 63/04

(52) U.S. Cl. 313/485; 313/581; 313/634

(57) ABSTRACT

A flat fluorescent lamp includes a body and a fluorescent layer. The body generates invisible radiation. The fluorescent layer has a luminance-enhancing pattern formed thereon. The fluorescent layer converts the invisible radiation into visible light. Therefore, a surface area of the fluorescent layer is increased to increase an amount of visible light, so that luminance of a display device employing the flat fluorescent lamp is enhanced.

### CROSS-REFERENCE TO RELATED APPLICATIONS

This application relies for priority upon Korean Patent Application No. 2004-41257 filed on Jun. 7, 2004, the content of which is herein incorporated by reference in its entirety.

### BACKGROUND OF THE INVENTION

1. Field of the Invention

The present invention relates to a flat fluorescent lamp, a method of manufacturing the flat fluorescent lamp and a display device having the flat fluorescent lamp. More particularly, the present invention relates to a flat fluorescent lamp with enhanced luminance and light uniformity, a method of manufacturing the flat fluorescent lamp, and a display device having the flat fluorescent lamp.

2. Description of the Related Art

When an electric field is applied to liquid crystal molecules, the arrangement of the liquid crystal molecules is altered according to the strength and direction of the electric field. The optical transmissivity of the liquid crystal molecules changes depending on the arrangement of the liquid crystal molecules.

A liquid crystal display (LCD) device displays an image by using the optical response of the liquid crystal molecules to electrical properties. In order to display an image, the LCD device uses an external light source. In some cases, this external light source is incorporated into the LCD device in the form of a backlight assembly.

The backlight assembly employs a light emitting diode (LED), a cold cathode fluorescent lamp (CCFL), or a flat fluorescent lamp, among other options. The flat fluorescent lamp provides higher luminance and luminance uniformity than the LED or the CCFL. However, the luminance and the light uniformity can still be optimized for a flat fluorescent lamp.

### SUMMARY OF THE INVENTION

The present invention provides a flat fluorescent lamp having enhanced luminance and luminance uniformity.

The present invention also provides a method of manufacturing the above-mentioned flat fluorescent lamp.

The present invention also provides a display device having the above-mentioned flat fluorescent lamp.

In an exemplary flat fluorescent lamp according to the present invention, the flat fluorescent lamp includes a body and a fluorescent layer. The body generates invisible radiation. The fluorescent layer has a luminance-enhancing pattern formed thereon. The fluorescent layer converts the invisible radiation into visible light.

In another exemplary flat fluorescent lamp according to the present invention, the flat fluorescent lamp includes a body and a fluorescent layer. The body generates invisible radiation. The fluorescent layer has at least one embossing pattern formed thereon. The fluorescent layer converts the invisible radiation into visible light. The embossing pattern increases a surface area to increase an amount of the visible light.

In an exemplary method of manufacturing a flat fluorescent lamp, a fluorescent layer having luminance-enhancing pattern to increase a surface of the fluorescent layer is formed over a first substrate. The first substrate is assembled with a second substrate to define at least two discharge spaces. Then, a pair of electrodes is formed at first and second end portions of at least one of the first and second substrates, the first and second end portions being on opposite sides of at least one of the first and second substrates.

In an exemplary display device according to the present invention, the display device includes a flat fluorescent lamp and a display panel. The flat fluorescent lamp includes a body and a fluorescent layer. The body has a plate shape and generates invisible radiation. The fluorescent layer has a luminance-enhancing pattern formed thereon. The fluorescent layer converts the invisible radiation into visible light. The display panel converts the visible light generated from the flat fluorescent lamp into an image.

According to the present invention, a surface of the fluorescent layer is increased to increase an amount of visible light. Therefore, luminance is enhanced.

### BRIEF DESCRIPTION OF THE DRAWINGS

The above and other features and advantages of the present invention will become more apparent through descriptions of their detailed exemplary embodiments with reference to the accompanying drawings, in which:

FIG. 1 is a partially cutout perspective view illustrating a flat fluorescent lamp according to an exemplary embodiment of the present invention;

FIG. 2 is a cross-sectional view taken along a line I-I′ in FIG. 1;

FIG. 3 is an enlarged view of a portion ‘A’ in FIG. 2;

FIG. 4 is an enlarged view of a portion ‘B’ in FIG. 2;

FIG. 5 is a plan view illustrating a portion of a fluorescent layer in FIG. 1;

FIG. 6 is a plan view illustrating another luminance-enhancing pattern;

FIG. 7 is a plan view illustrating yet another luminance-enhancing pattern;

FIG. 8 is a partially cutout perspective view illustrating a flat fluorescent lamp according to another exemplary embodiment of the present invention;

FIG. 9 is a cross-sectional view taken along a line II-II′ in FIG. 8;

FIG. 10 is a partially cutout perspective view illustrating a flat fluorescent lamp according to still another exemplary embodiment of the present invention;

FIG. 11 is a cross-sectional view taken along a line III-III′ in FIG. 10;

FIG. 12 is a cross-sectional view illustrating a mask for forming a fluorescent layer, which is aligned over a first substrate;

FIG. 13 is a cross-sectional view illustrating the fluorescent layer having luminance-enhancing pattern and formed on the first substrate in FIG. 12;

FIG. 14 is a cross-sectional view illustrating partition members formed on the first substrate having the luminance-enhancing pattern in FIG. 13;

FIG. 15 is a cross-sectional view illustrating a second substrate assembled with the first substrate in FIG. 14;

FIG. 16 is a cross-sectional view illustrating a light-reflecting layer formed on the first substrate;

FIG. 17 is a cross-sectional view illustrating a fluorescent layer formed on the light-reflecting layer in FIG. 16;

FIG. 18 is a cross-sectional view illustrating embossing patterns formed on the fluorescent layer in FIG. 17;

FIG. 19 is a cross-sectional view illustrating a partition member formed on the first substrate in FIG. 18;

FIG. 20 is a cross-sectional view illustrating a second substrate assembled with the first substrate in FIG. 19; and

FIG. 21 is an exploded perspective view illustrating a display device according to an exemplary embodiment of the present invention.

### DESCRIPTION OF EMBODIMENTS

It should be understood that the exemplary embodiments of the present invention described below may be varied or modified in many different ways without departing from the inventive principles disclosed herein, and that the scope of the present invention is therefore not limited to these particular embodiments. Rather, these embodiments are provided so that this disclosure will be thorough and complete, and will fully convey the concept of the invention to those skilled in the art by way of example and not of limitation.

Hereinafter, the embodiments of the present invention will be described in detail with reference to the accompanied drawings.

Flat Fluorescent Lamp

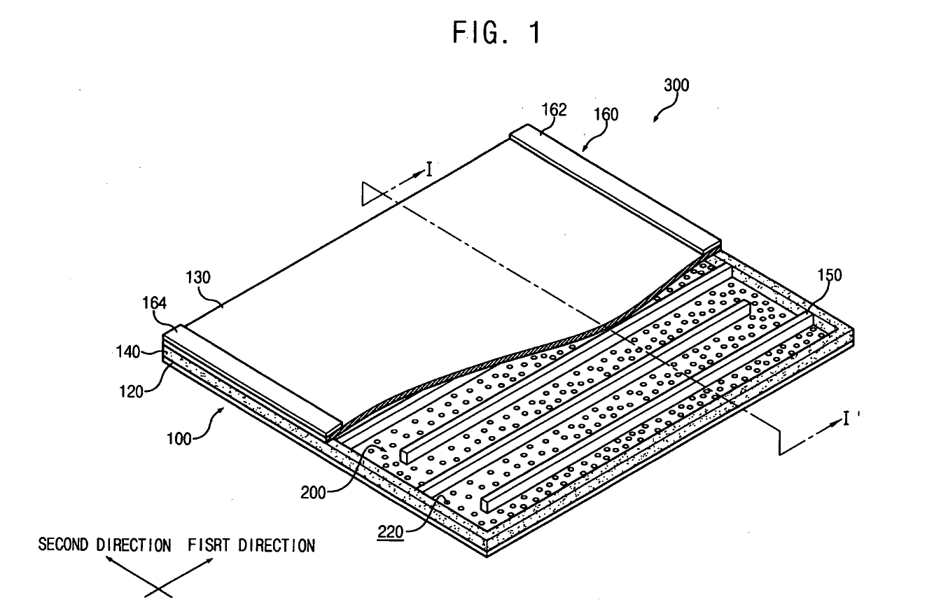

FIG. 1 is a partially cutout perspective view illustrating a flat fluorescent lamp according to an exemplary embodiment of the present invention.

Referring to FIG. 1, a flat fluorescent lamp 300 according to an exemplary embodiment of the present invention includes a body 100 and a fluorescent layer 200. The body 100 has a plate shape having a light-emitting space (or discharge space) formed therein. The light-emitting space contains discharge gas. When a discharge voltage is applied to the discharge gas, the discharge gas generates invisible radiation such as ultraviolet light. The fluorescent layer 200 transforms the invisible radiation into visible light.

The fluorescent layer 200 has a luminance-enhancing pattern 220 formed thereon. The luminance-enhancing pattern includes a plurality of texture elements arranged in a predefined manner. The fluorescent layer 200 is disposed on an inner surface of the body 100. The luminance-enhancing pattern 220 increases the surface area of the fluorescent layer 200, increasing the amount of visible light generated from the fluorescent layer 200.

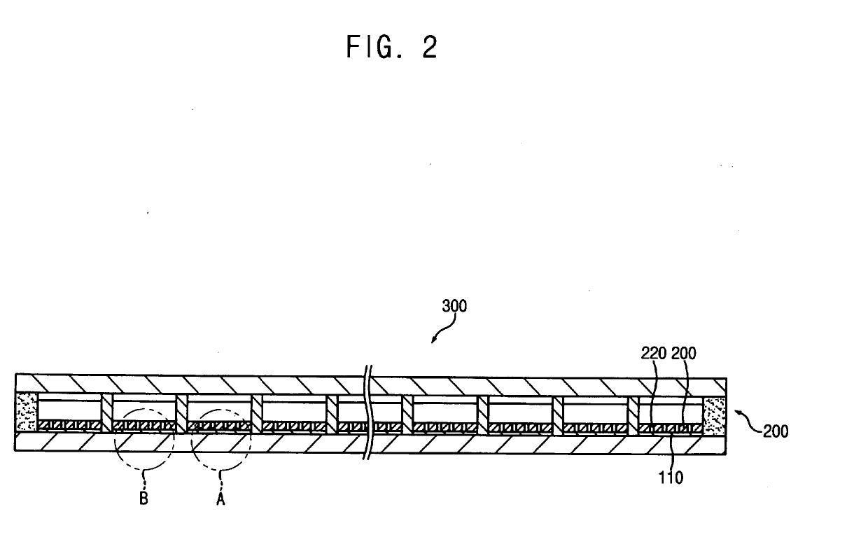

FIG. 2 is a cross-sectional view taken along a line I-I′ in FIG. 1.

The texture elements in the luminance-enhancing pattern 220 according to this embodiment are recesses. The fluorescent layer 200 having the luminance-enhancing pattern 220 is formed on a light-reflecting layer 110. The light-reflecting layer 110 reflects visible light generated by the fluorescent layer 200.

The luminance-enhancing pattern 220 of the fluorescent layer 200 increases the surface area of the fluorescent layer 200 to increase the amount of visible light.

Each of the recesses may have a depth that is substantially equal to a thickness of the fluorescent layer 200. Alternatively, the recesses may have a depth that is less than the thickness of the fluorescent layer 200.

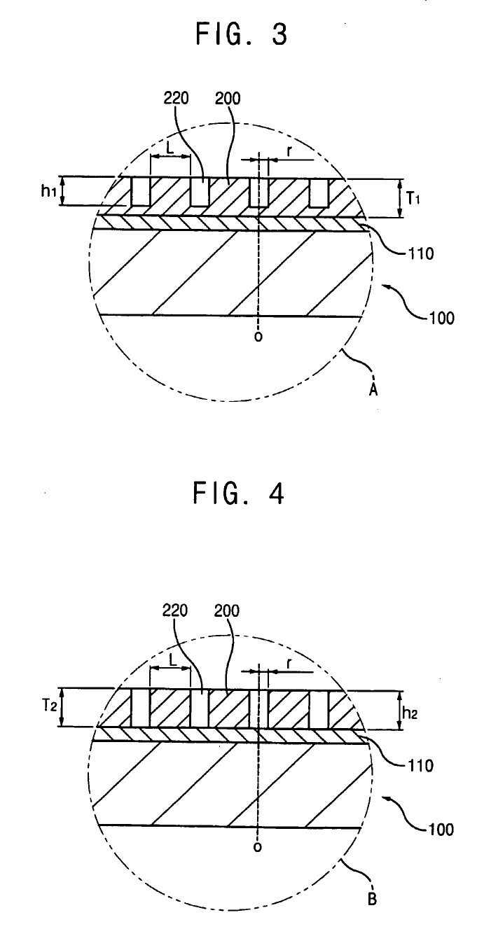

FIG. 3 is an enlarged view illustrating the portion ‘A’ of FIG. 2.

In FIG. 3, the luminance-enhancing pattern 220 has a depth h1 that is less than a thickness T1 of the fluorescent layer 200. When the depth h1 of the luminance-enhancing pattern 220 is less than the thickness T1 of the fluorescent layer 200, the surface area of the fluorescent layer 200 becomes greater to increase the amount of visible light.

FIG. 4 is an enlarged view illustrating the portion ‘B’ of FIG. 2.

In FIG. 4, the luminance-enhancing pattern 220 has a depth h2 that is substantially same as a thickness T2 of the fluorescent layer 200. When the depth h2 of the luminance-enhancing pattern 220 is substantially same as the thickness T2 of the fluorescent layer 200, the light-reflecting layer 110 is exposed. The light-reflecting layer 110 reflects any incident visible light to increase the amount of visible light emitted from the flat fluorescent lamp 300.

Referring again to FIG. 3, the luminance-enhancing pattern 220 satisfies the relation r<2xh1, wherein ‘r’ represents a distance between a center and an edge of one of the luminance-enhancing pattern 220, and ‘h1’ represents the thickness of the fluorescent layer 200.

When the thickness h1 of the fluorescent layer 200 is, for example, about 30 μm, the distance ‘r’ is, for example, equal to or less than 15 μm. When the thickness h1 of the fluorescent layer 200 is, for example, about 100 μm, the distance ‘r’ is, for example, equal to or less than 50 μm.

A distance between two neighboring recesses in the luminance-enhancing pattern 220 is, for example, equal to or greater than 2r.

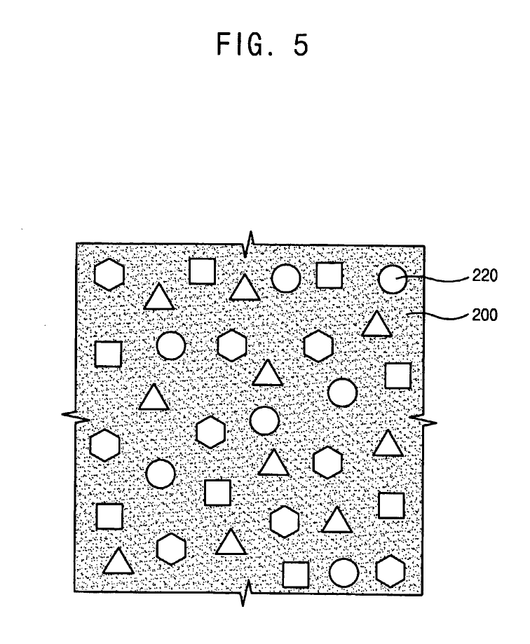

FIG. 5 is a plan view illustrating a portion of a fluorescent layer in FIG. 1.

As shown in FIG. 5, the texture elements of the luminance-enhancing pattern 220 may have various shapes. A cross-section of a texture element may have, for example a circle, an oval, a triangle, a rectangle, a trapezoid, and/or a polygon shape, among others. In some cases, the texture elements formed on the fluorescent layer 200 may have a mix of at least two different shapes.

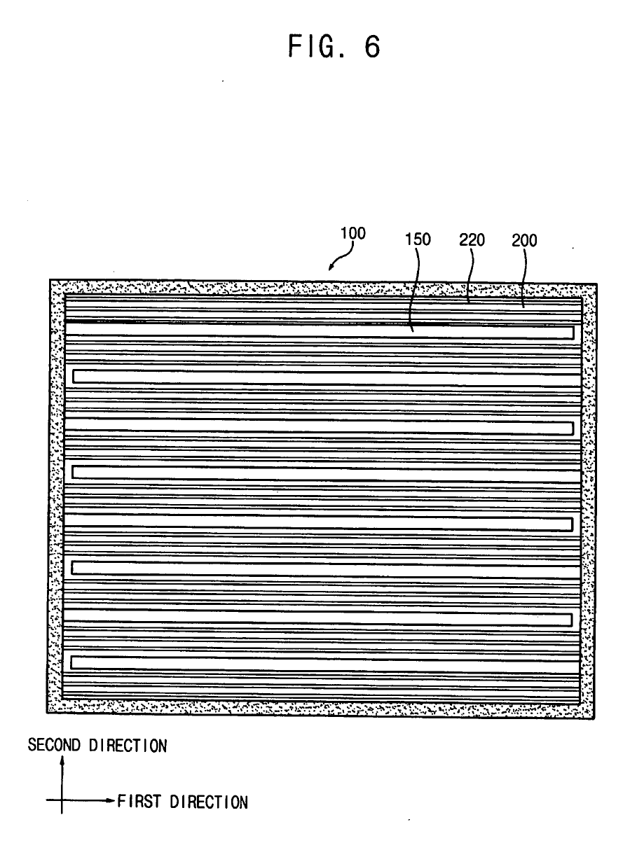

FIG. 6 is a plan view illustrating another luminance-enhancing pattern.

Referring to FIGS. 1 and 6, the texture elements of the luminance-enhancing pattern 220 are grooves. In detail, each groove of the luminance-enhancing pattern 220 extends along a first direction that is substantially parallel to a partition member 150, and at least two of the grooves are arranged along a second direction that is substantially perpendicular to the first direction.

The depth of the luminance-enhancing pattern 220 may be less than the depth of the fluorescent layer 200. Alternatively, the depth of the luminance-enhancing pattern 220 may be substantially equal to a depth of the fluorescent layer 200 in order to expose the light-reflecting layer 110.

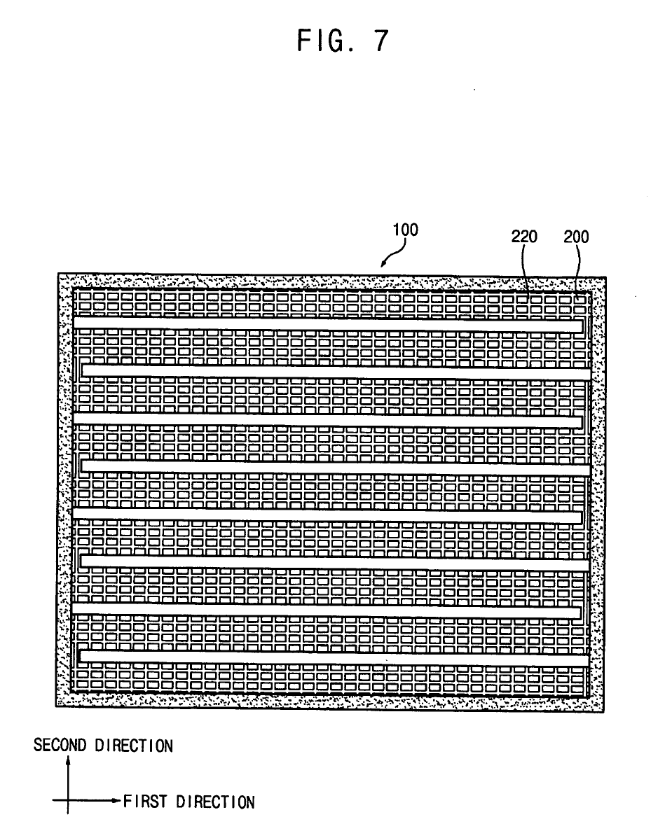

FIG. 7 is a plan view illustrating still another luminance-enhancing pattern.

Referring to FIG. 7, the recesses of the luminance-enhancing pattern 220 may have a rectangular cross section and may be arranged to form a matrix.

The depth of the luminance-enhancing pattern 220 may be less than the depth of the fluorescent layer 200. Alternatively, the depth of the luminance-enhancing pattern 220 may be substantially equal to a depth of the fluorescent layer 200 in order to expose the light-reflecting layer 110.

Referring again to FIG. 1, the body 100 includes a first substrate 120, a second substrate 130, a sealing member 140, a partition member 150 and an electrode part 160 having a first electrode 162 and a second electrode 164.

The first substrate 120 is optically transparent. A glass substrate may be employed as the first substrate 120. The first substrate 120 may have a rectangular shape.

The second substrate 130 may be optically transparent or opaque. The second substrate 130 has an identical shape as the first substrate, which in this case is rectangular.

The sealing member 140 is disposed between the first and second substrates 120 and 130. The sealing member 140 is disposed along the edges of the first and second substrates 120 and 130. The sealing member 140 may be disposed to form a rectangular frame shape along the edges of the first and second substrates 120 and 130 to define the light-emitting space framed by the sealing member 140.

The partition member 150 is disposed in the light-emitting space. At least two partition members 150 may be disposed in the light-emitting space. The partition member 150 divides the light-emitting space into sub light-emitting spaces. The partition member 150 may include a through-hole that connects the sub light-emitting spaces adjacent to each other. The partition members 150 extend in a direction that is substantially parallel to the first direction. The partition members 150 are arranged in the second direction.

A discharge gas (not shown) is injected into the light-emitting space defined by the sealing member 140 and the first and second substrates 120 and 130. When a discharge voltage is applied to the discharge gas, the discharge gas generates ultraviolet radiation.

The fluorescent layer 200 is formed on an inner surface of the second substrate 130. The inner surface of the second substrate 130 faces the first substrate 120. The fluorescent layer 200 is also formed on the inner surface of the first substrate 120. The inner surface of the first substrate 120 faces the second substrate 130. The fluorescent layer 200 transforms the ultraviolet radiation generated from the discharge gas into visible light. As the luminance-enhancing pattern 220 on the fluorescent layer has been described above, any further explanation of the luminance-enhancing pattern will be omitted.

The first electrode 162 is disposed along a first edge of the body 100. The second electrode 164 is disposed along a second edge of the body 100. The first and second edges of the body 100 are on opposite sides of the body 100. The first and second electrodes 162 and 164 are disposed along the second direction, so that the first and second electrodes 162 and 164 are substantially perpendicular to the partition members 150. The first and second electrodes 162 and 164 apply the discharge voltage to the discharge gas. The first and second electrodes 162 and 164 may be disposed on an outer surface of the body 100. Alternatively, at least one of the first and second electrodes 162 and 164 may be disposed in the lamp body 100.

When the discharge voltage is applied to the discharge gas, the discharge gas generates ultraviolet light. The ultraviolet light generated by the discharge gas is transformed into visible light by the fluorescent layer 200. The fluorescent layer 200 has a greater surface area due to the luminance-enhancing pattern 210. Therefore, the amount of the visible light generated by the fluorescent layer 200 is increased to enhance luminance of visible light that exits the flat fluorescent lamp 300.

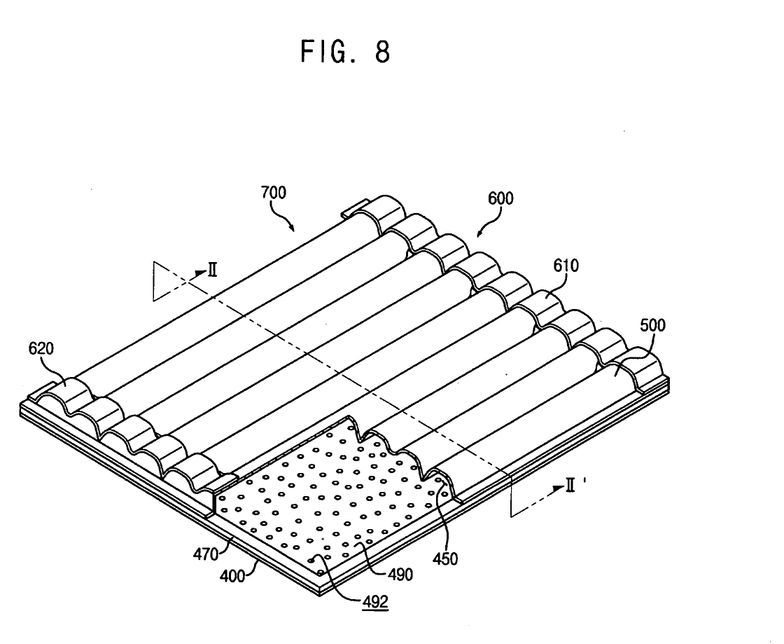

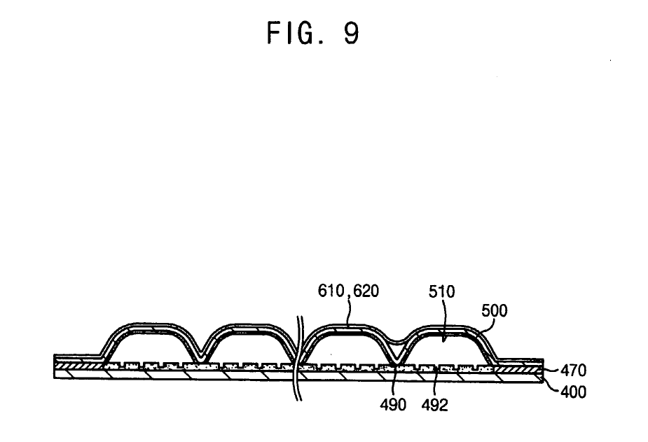

FIG. 8 is a partially cutout perspective view illustrating a flat fluorescent lamp according to another exemplary embodiment of the present invention. FIG. 9 is a cross-sectional view taken along a line II-II′ in FIG. 8.

Referring to FIGS. 8 and 9, a flat fluorescent lamp 700 according to another exemplary embodiment of the present invention includes a first substrate 400, a second substrate 500, and an electrode part 600.

The first substrate 400 has, for example, a rectangular shape. A glass substrate that transmits visible light and blocks invisible radiation may be employed as the first substrate 400.

The second substrate 500 is combined with the first substrate 400. When the first and second substrates 400 and 500 are combined with each other, at least two light-emitting spaces 450 are defined between the first and second substrates 400 and 500. A glass substrate that transmits visible light and blocks invisible radiation may be employed as the second substrate 500.

The second substrate 500 includes, for example, a plurality of furrows. When the first and second substrates 400 and 500 are combined with each other, an inner surface portion corresponding to the furrows makes contact with the first substrate 400 to define the light-emitting spaces 450. The furrows extend, for example, substantially parallel to an edge of the flat fluorescent lamp 700. The furrows may be spaced apart at a regular interval. The second substrate 500 having the furrows may be manufactured through a forming process. In detail, a flat glass plate is heated and then compressed to form the second substrate 500 having the furrow.

A cross-section of each of the light-emitting spaces 450 may have, for example, a trapezoidal shape, a semicircular shape, or a rectangular shape, among others. The light-emitting spaces 450 are connected to each other.

The first and second substrates 400 and 500 are combined with each other through a sealing member 470 such as a frit including metal and glass. The frit has a lower melting point than glass. The frit is disposed along the edge portions of the first and second substrates 400 and 500, and the first and second substrates 400 and 500 are compressed when the frit is heated, so that the first and second substrates 400 and 500 are combined with each other. When the first and second substrates 400 and 500 are combined with each other, air in the light-emitting spaces 450 is expelled and the discharge gas is injected into the light-emitting spaces 450. The inner surface portion corresponding to the furrows makes contact with the first substrate 400 due to a pressure difference between the light-emitting spaces 450 and the atmosphere. The discharge gas, for example, includes mercury (Hg), argon (Ar), neon (Ne), xenon (Xe), krypton (Kr), etc.

The electrode part 600 includes a first electrode 610 and a second electrode 620. The first electrode 610 is disposed along a first edge on an outer surface of the second substrate 500. The second electrode 620 is disposed along a second edge on the outer surface of the second substrate 500. The first edge of the second substrate 500 and the second edge of the second substrate 500 are on opposite sides of the substrate 500. The first and second electrodes 610 and 620 extend in a direction that is substantially perpendicular to the direction in which the light-emitting spaces 450 extend. The first and second electrodes 610 and 620 include a metal having a high electrical conductivity such as copper (Cu), nickel (Ni), aluminum (Al), silver (Ag), etc. The first and second electrodes 610 and 620 may be formed through an aluminum tape, silver paste, or any other suitable method. The first and second electrodes 610 and 620 may be formed on the outer surface of the first substrate 400. Alternatively, the first and second electrodes 610 and 620 may be formed on the outer surfaces of the first and second substrates 400 and 500.

When a discharge voltage is applied to the discharge gas through the first and second electrodes 610 and 620, the discharge gas generates ultraviolet light. The ultraviolet light may be transformed into visible light through fluorescent layers.

The flat fluorescent lamp 700 further includes a first fluorescent layer 490 and optionally a light-reflecting layer (not shown). The light-reflecting layer is formed on an inner surface of the first substrate 400. The first fluorescent layer 490 is disposed on the light-reflecting layer. The first fluorescent layer 490 transforms the ultraviolet radiation generated from the discharge gas into visible light.

The first fluorescent layer 490 includes the luminance-enhancing pattern 492 in order to enhance the luminance of the fluorescent lamp 700. The luminance-enhancing pattern 492 increases the surface area of the first fluorescent layer 490. Therefore, an amount of the visible light is also increased. The luminance-enhancing pattern may have any shape as long as the luminance-enhancing pattern increases the surface area of the first fluorescent layer 490. The depth of the luminance-enhancing pattern 492 is substantially equal to or less than the thickness of the first fluorescent layer 490.

The flat fluorescent lamp 700 may further include a second fluorescent layer 510. The second fluorescent layer 510 is formed on an inner surface of the second substrate 500. The second fluorescent layer 510 also transforms the ultraviolet light generated from the discharge gas into visible light.

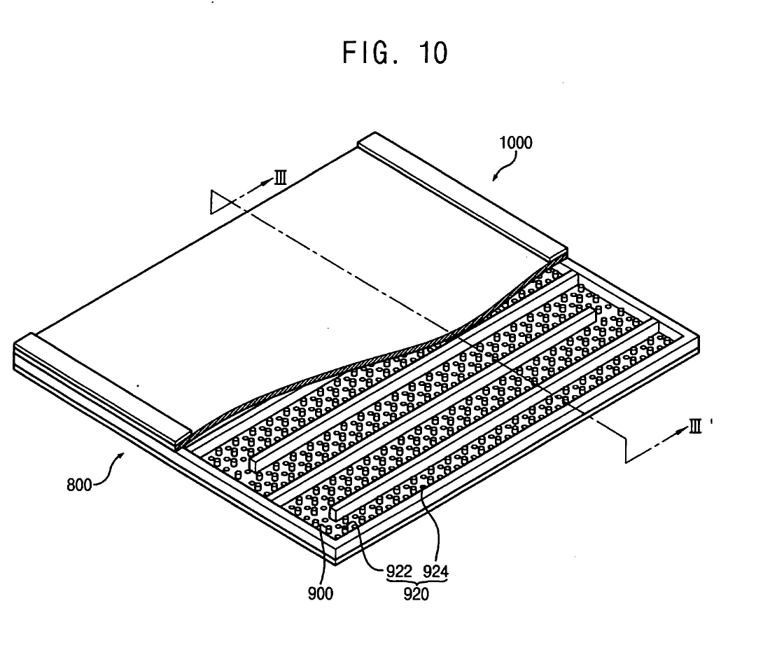

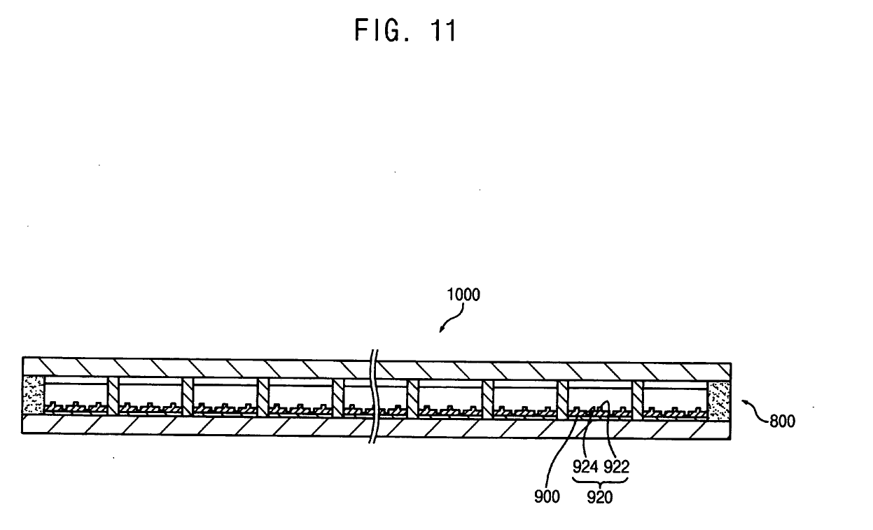

FIG. 10 is a partially cutout perspective view illustrating a flat fluorescent lamp according to still another exemplary embodiment of the present invention. FIG. 11 is a cross-sectional view taken along a line III-III′ in FIG. 10.

Referring to FIGS. 10 and 11, a flat fluorescent lamp 1000 includes a body 800 and a fluorescent layer 900. The body 800 has a light-emitting space formed therein. The body 800 has, for example, a rectangular shape. When a discharge voltage is applied to the discharge gas contained in the light-emitting space, invisible radiation such as ultraviolet radiation is generated.

The fluorescent layer 900 transforms the ultraviolet radiation into visible light. The fluorescent layer 900 has an embossing pattern 920 formed thereon. The fluorescent layer 900 is formed on an inner surface of the body 800. The embossing pattern 920 increases the surface area of the fluorescent layer 900 to enhance the luminance of the flat fluorescent lamp 1000.

Each texture element in the embossing pattern 920 may have an any shape as long as the embossing pattern increase the surface area of the fluorescent layer 900. In the present embodiment, the embossing pattern 920 includes protrusions 922 and indentations 924. The protrusions 922 protrude from the fluorescent layer 900, and the indentations 924 are recessed from the fluorescent layer 900. The depth of the indentations 924 may be substantially equal to or less than the thickness of the fluorescent layer 900.

In the present embodiment, the embossing patterns 900 include both the protrusions 922 and the indentations 924. Alternatively, the embossing patterns 900 may include only the protrusions 922.

Method of Manufacturing a Flat Fluorescent Lamp

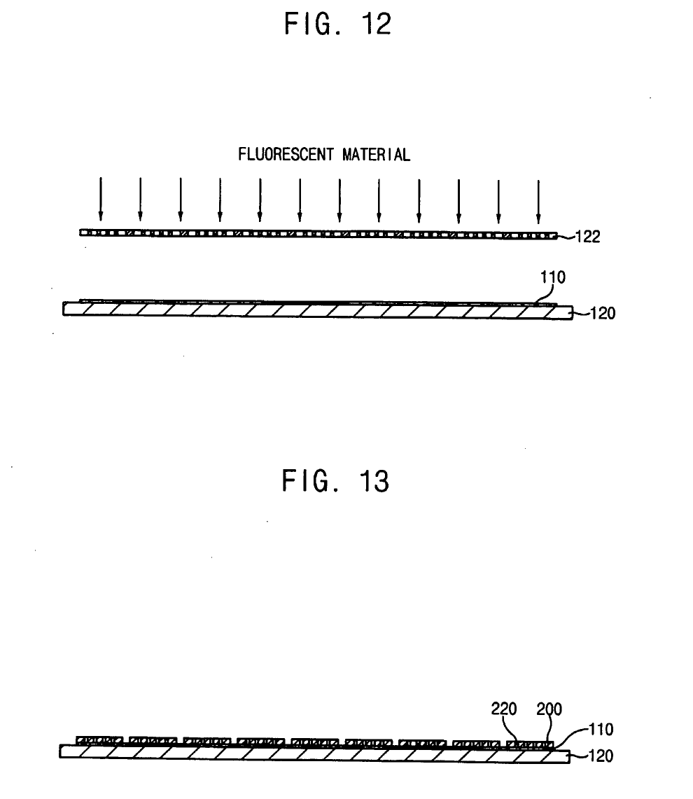

FIGS. 12 through 15 illustrate the steps for manufacturing a flat fluorescent lamp according to an exemplary embodiment of the present invention.

FIG. 12 is a cross-sectional view illustrating a mask for forming a fluorescent layer, wherein the mask is aligned over a first substrate.

Referring to FIG. 12, a light-reflecting layer 110 having a high optical reflectivity is formed on a first substrate 120. The light-reflecting layer 110 may be formed to have uniform thickness, for example through a sputtering method, a chemical vapor deposition (CVD) method, etc.

When the light-reflecting layer 110 is formed on the first substrate 120, a slit mask 122 is disposed over the first substrate 120 having the light-reflecting layer 110 formed thereon. The slit mask 122 has a blocking portion and an opening portion.

FIG. 13 is a cross-sectional view illustrating the fluorescent layer having the luminance-enhancing pattern and formed on the first substrate in FIG. 12.

Referring to FIG. 13, when the slit mask 122 is aligned over the first substrate 120, the fluorescent material is, for example, sprayed toward the slit mask 122 disposed over the first substrate 120. The fluorescent material passing through the opening portion of the slit mask 122 is accumulated on the light-reflecting layer 110 to form the fluorescent layer 200. The fluorescent material is blocked by the blocking portion of the slit mask 122, so that the fluorescent material is not accumulated partially to form a recessed portion corresponding to the luminance-enhancing pattern 220.

The luminance-enhancing pattern 220 may have various cross-section shapes, such as a circle, a triangle, a rectangle, or a polygon, among others. The depth of the luminance-enhancing pattern and the thickness of the fluorescent layer 200 may be adjusted by adjusting the spraying duration the fluorescent material and the distance between the slit mask 122 and the first substrate 120.

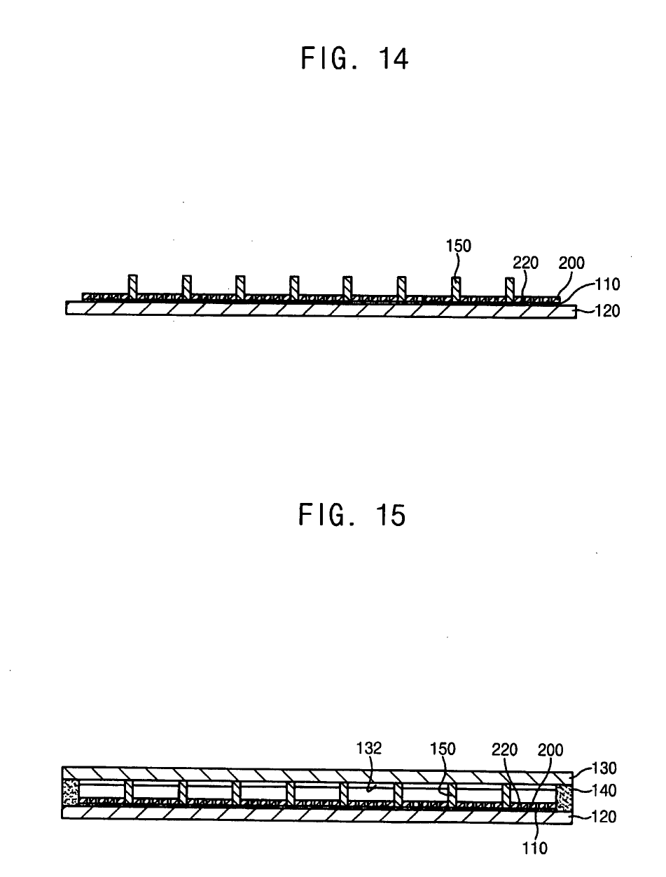

FIG. 14 is a cross-sectional view illustrating partition members formed on the first substrate having the luminance-enhancing pattern of FIG. 13.

Referring to FIG. 14, when the luminance-enhancing pattern 220 is formed on the light-reflecting layer 110, partition members 150 are formed. The partition members 150 are disposed, for example, on a portion of the light-reflecting layer 110 that is exposed through the fluorescent layer 200. The partition member 150 divides a surface of the first substrate 120 into a plurality of subspaces. The partition member 150 may be formed with ceramic.

Hereinbefore, the partition member 150 is formed after the fluorescent layer 200 is formed. Alternatively, the partition member 150 may be formed before the fluorescent layer 200 is formed.

FIG. 15 is a cross-sectional view illustrating a second substrate assembled with the first substrate in FIG. 14.

Referring to FIG. 15, a second substrate 130 is assembled with the first substrate 120 having the partition member 150 formed thereon by a sealing member 140. The second substrate 130 may have a substantially identical shape to the first substrate 120. The second substrate 130 may include another fluorescent layer 132.

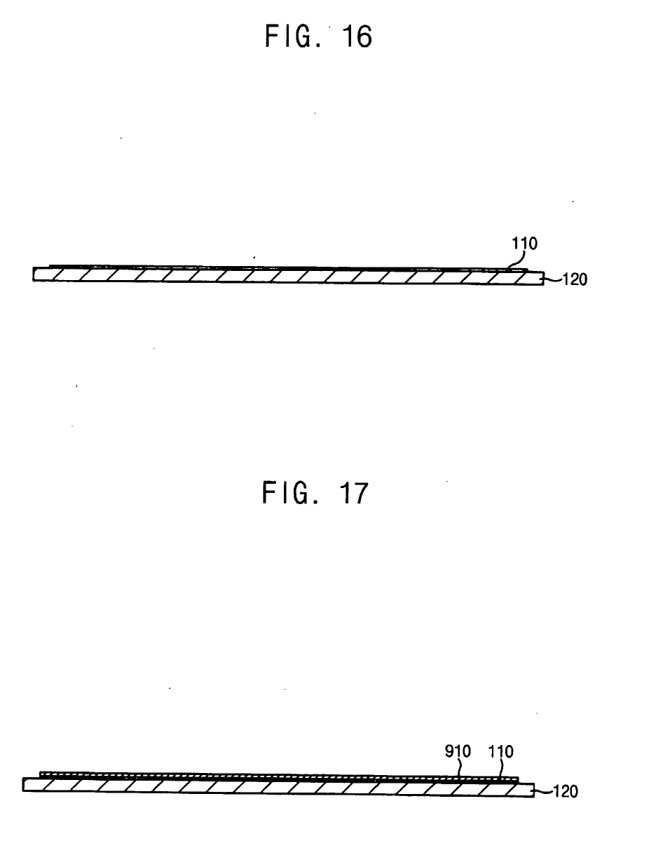

FIGS. 16 through 20 illustrating steps of manufacturing a flat fluorescent lamp according to another exemplary embodiment of the present invention.

FIG. 16 is a cross-sectional view illustrating a light-reflecting layer formed on the first substrate.

Referring to FIG. 16, a light-reflecting layer 110 having a high optical reflectivity is formed on a first substrate 120. The light-reflecting layer 110 may be formed to have uniform thickness, for example through a sputtering method, a chemical vapor deposition (CVD) method, etc.

FIG. 17 is a cross-sectional view illustrating a fluorescent layer formed on the light-reflecting layer in FIG. 16.

Referring to FIG. 17, the fluorescent material is coated on the light-reflecting layer 110 to form a primitive fluorescent layer 910 having a uniform thickness.

FIG. 18 is a cross-sectional view illustrating embossing patterns formed on the fluorescent layer in FIG. 17.

Referring to FIG. 18, the embossing pattern 920 is formed on the primitive fluorescent layer 910. A roller 900c having protruding portions 900a and a recessed portions 900b rolls to form the protrusions 922 and the indentations 924. Alternatively, the roller 900c may include only one of the protruded portions 900a or the recessed portions 900b. The roller 900c rolls before the primitive fluorescent layer 910 is hardened.

The embossing pattern 920 is not limited to any particular shapes as long as the embossing pattern 920 increases the surface area of the fluorescent layer. The embossing pattern 920 may have, for example, a circular shape, a triangular shape, a rectangular shape, a polygonal shape, etc.

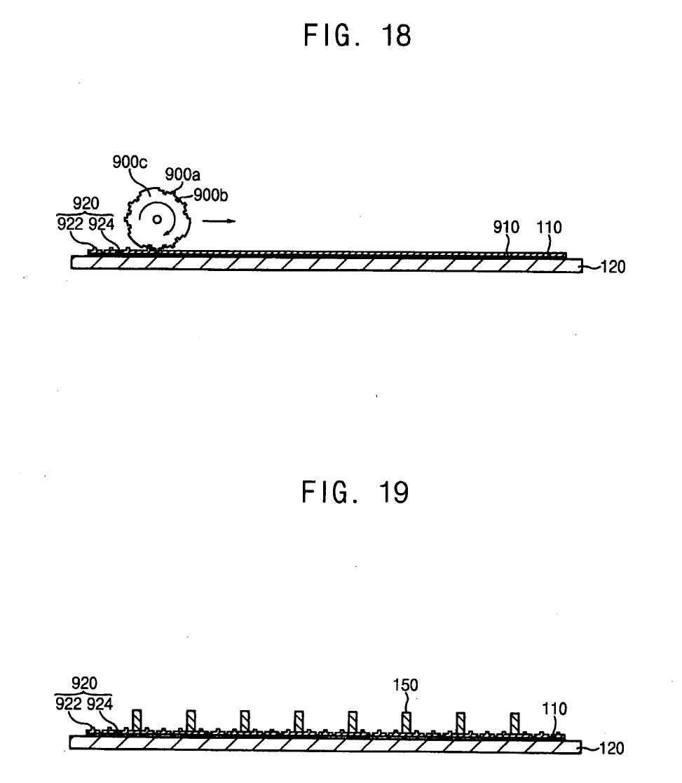

FIG. 19 is a cross-sectional view illustrating a partition member formed on the first substrate in FIG. 18.

Referring to FIG. 19, after the embossing pattern 920 is formed on the light-reflecting layer 110, the partition members 150 are formed. The partition members 150 are disposed, for example, on a fluorescent layer having the embossing pattern 920. The partition member 150 divides a surface of the first substrate 120 into a plurality of subspaces. The partition member 150 may be formed with ceramic.

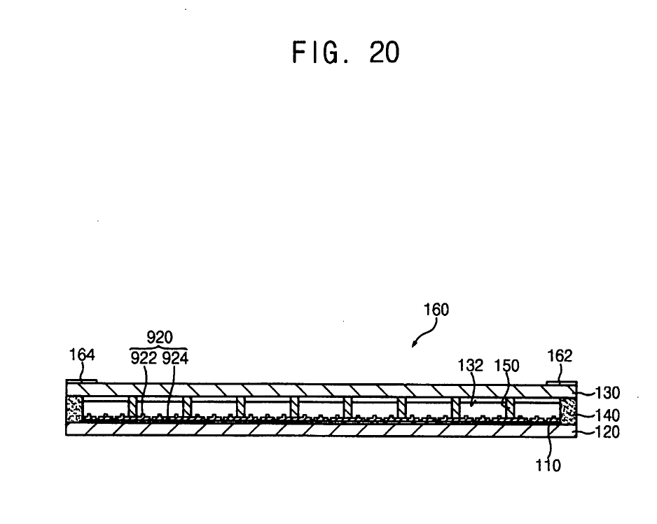

FIG. 20 is a cross-sectional view illustrating a second substrate assembled with the first substrate in FIG. 19.

Referring to FIG. 20, a second substrate 130 is assembled with the first substrate 120 having the partition member 150 formed thereon by a sealing member 140. The second substrate 130 may have a substantially identical shape to the first substrate 120. The second substrate 130 may include another fluorescent layer 132.

According to the present embodiment, the first and second substrates 120 and 130 have a plate shape. Alternatively, one of the first and second substrates 120 and 130 corresponds to the second substrate 500.

Display Device

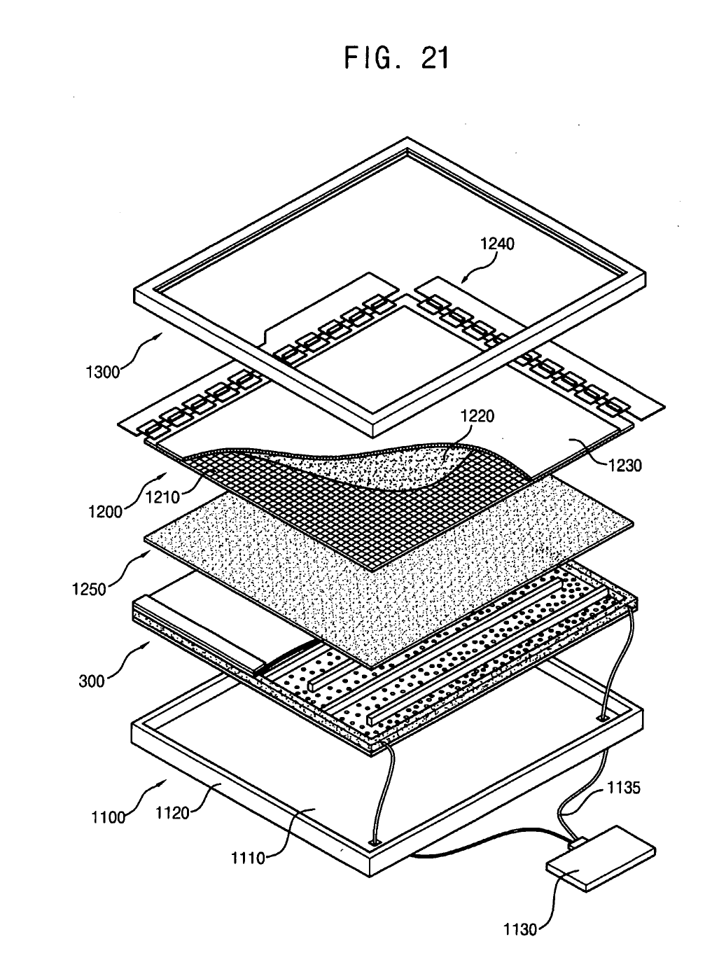

FIG. 21 is an exploded perspective view illustrating a display device according to an exemplary embodiment of the present invention. The flat fluorescent lamp in the display device may be any one of the above-described flat fluorescent lamps. Thus, any further explanation regarding the flat fluorescent lamps will be omitted.

Referring to FIG. 21, a display device 1400 includes a receiving container 1100, a flat fluorescent lamp 300, a display panel 1200 and a chassis 1300. The receiving container 1100 includes a bottom plate 1110 sidewalls 1120 extending from edge portions of the bottom plate 1110, and a discharge voltage-applying module 1130. The receiving container fixes the flat fluorescent lamp 300 and the display panel 1200. The bottom plate 1110 has sufficient area for receiving the flat fluorescent lamp 300. The bottom plate 1110, which may have a rectangular shape, holds the flat fluorescent lamp 300. The sidewalls 1120 fix the flat fluorescent lamp 300 in position relative to the receiving container 1100. The discharge voltage-applying module 1130 applies a discharge voltage to the first and second electrodes 162 and 164.

The display panel 1200 converts light generated from the flat fluorescent lamp 300 into images. The display panel 1200 includes a thin film transistor (TFT) substrate 1210, a liquid crystal layer 1220, a color filter substrate 1230 and a driving module 1240.

The TFT substrate 1210 includes a plurality of pixel electrodes arranged in a matrix shape, a plurality of TFTs electrically connected to the pixel electrodes, a plurality of gate lines electrically connected to the TFTs, and a plurality of data lines electrically connected to the TFTs. The color filter substrate 1230 faces the TFT substrate 1210. The color filter substrate 1230 includes a plurality of color filters and a common electrode. The color filters face the pixel electrodes. The common electrode is formed on the color filters. The liquid crystal layer 1220 is disposed between the TFT substrate 1210 and the color filter substrate 1230.

The chassis 1300 fits around the edge portions of the display panel 1200 and is combined with the sidewall 1120 of the receiving container 1100, for example by using a hook mechanism. The chassis 1300 fixes and protects the display panel 1200. An optical member 1250 disposed on the flat fluorescent lamp 300 enhances the optical properties of the light generated from the flat fluorescent lamp 300.

According to the present invention, the luminance-enhancing pattern formed on the fluorescent layer increases the surface area of the fluorescent layer. Therefore, the amount of visible light generated from the fluorescent layer increases to enhance luminance.

When the luminance is not uniform throughout a surface of the flat fluorescent lamp, the luminance of the flat fluorescent lamp may be adjusted to be uniform by adjusting density of the luminance-enhancing pattern.

Having described the exemplary embodiments of the present invention and its advantages, it is noted that various changes, substitutions and alterations can be made herein without departing from the spirit and scope of the invention as defined by appended claims.

1. A flat fluorescent lamp comprising:
a body generating invisible radiation; and
a fluorescent layer having a luminance-enhancing pattern formed thereon, the fluorescent layer converting the invisible radiation into visible light.

2. The flat fluorescent lamp of claim 1, wherein the body has a light-emitting space formed therein, and the fluorescent layer is disposed on an inner surface of the body, the inner surface defining the light-emitting space.

3. The flat fluorescent lamp of claim 1, wherein the luminance-enhancing pattern includes at least one recessed portion.

4. The flat fluorescent lamp of claim 3, wherein a depth of the recessed portion is substantially equal to or less than a thickness of the fluorescent layer.

5. The flat fluorescent lamp of claim 3, wherein the recessed portion is formed to satisfy a relation of r<2h, wherein ‘r’ represents a shortest distance between a center of the recessed portion and edges of the recessed portion, and ‘h’ represents a thickness of the fluorescent layer.

6. The flat fluorescent lamp of claim 3, wherein a cross section of the recessed portion has at least one of a polygonal shape and a circular shape from a plan view perspective.

7. The flat fluorescent lamp of claim 1, wherein the luminance-enhancing pattern includes at least one groove extending along a line.

8. The flat fluorescent lamp of claim 7, wherein a depth of the groove is substantially equal to or less than a thickness of the fluorescent body.

9. The flat fluorescent lamp of claim 1, wherein the luminance-enhancing pattern includes texture elements arranged in a matrix shape, wherein each of the texture elements has a rectangular shape.

10. The flat fluorescent lamp of claim 9, wherein a depth of the luminance-enhancing pattern is substantially equal to or less than a thickness of the fluorescent layer.

11. The flat fluorescent lamp of claim 1, further comprising a light-reflecting layer that is interposed between the body and the fluorescent layer.

12. The fluorescent lamp of claim 1, wherein a distance between neighboring elements that form the luminance-enhancing pattern is substantially equal to a sum of a thickness and a width of one of the elements.

13. The fluorescent lamp of claim 1, wherein the body comprises:
a first substrate having a plate shape;
a second substrate having a plate shape and facing the first substrate;
a sealing member disposed between the first and second substrates, the sealing member defining a space between the first and second substrates, discharge gas that generates the invisible radiation being injected into the space when discharge voltage is applied to the discharge gas;
a partition member disposed at the space to divide the space into at least two discharge spaces; and
a pair of electrodes disposed at first and second end portions of the body to apply the discharge voltage to the discharge gas, the first and second ends being opposite to each other.

14. The flat fluorescent lamp of claim 13, wherein the fluorescent layer is disposed on an inner surface of the first and second substrates, the inner surface of the first substrate facing the second substrate and the inner surface of the second substrate facing the first substrate.

15. The flat fluorescent lamp of claim 1, wherein the body comprises:
a first substrate having a plate shape;
a second substrate combining with the first substrate to define a discharge space that has a serpentine shape; and
a pair of electrodes disposed at first and second end portions of the second substrate to apply discharge voltage to the discharge gas disposed in the discharge space.

16. The flat fluorescent lamp of claim 1, wherein. the embossing pattern increases a surface area of the fluorescent body to increase an amount of the visible light.

17. The flat fluorescent lamp of claim 16, wherein the embossing pattern protrudes from the fluorescent layer.

18. The flat fluorescent lamp of claim 16, wherein the embossing patterns have first embossing pattern portions protruding from the fluorescent body, and second embossing pattern portions recessed from the fluorescent body.

19. The flat fluorescent lamp of claim 18, wherein a height of the first embossing pattern portions is substantially equal to a thickness of the fluorescent body.

20. The flat fluorescent lamp of claim 18, wherein a depth of the second embossing pattern portions is substantially same as a thickness of the fluorescent body.

21. A method of manufacturing a flat fluorescent lamp, comprising:
forming a fluorescent layer having a luminance-enhancing pattern to increase a surface of the fluorescent layer over a first substrate;
assembling the first substrate with a second substrate to define at least two discharge spaces; and
forming a pair of electrodes at first and second end portions of at least one of the first and second substrates, the first and second end portions being on opposite sides of at least one of the first and second substrates.

22. The method of claim 21, wherein the luminance-enhancing pattern is formed by:
disposing a mask having mask patterns on the first substrate; and
providing the first substrate with fluorescent material through the mask.

23. The method of claim 21, wherein the luminance-enhancing pattern is formed by:
forming a primitive fluorescent layer over the first substrate; and
forming a luminance-enhancing pattern by compressing the primitive fluorescent layer with a member having patterns corresponding to the luminance-enhancing pattern.

24. The method of claim 23, further comprising forming a light-reflecting layer on the first substrate, prior to forming the primitive fluorescent layer.

25. The method of claim 21, wherein the luminance-enhancing pattern correspond to at least one of recessed portions and protruded portions.

26. The method of claim 21, further comprising disposing at least one partition member on the first substrate having a rectangular plate shape or the second substrate having a rectangular plate shape.

27. The method of claim 21, further comprising forming a light-reflecting layer on the first substrate.

28. A display device comprising:
a flat fluorescent lamp including a body generating invisible radiation, and a fluorescent layer having at least one embossing pattern formed thereon, the fluorescent layer converting the invisible radiation into visible light, the embossing pattern increasing a surface area of the fluorescent layer to increase an amount of the visible light; and
a display panel that converts the visible light generated from the flat fluorescent lamp into an image.
